(19) United States
(12) Patent Application Publication
(10) Pub. No.: US 2009/0160773 A1
(43) Pub. Date: Jun. 25, 2009

(54) OPTICAL MOUSE

(75) Inventors: David Bohn, Fort Collins, CO (US); Mark DePue, Issaquah, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/960,755

(22) Filed: Dec. 20, 2007

(51) Int. Cl. G06F 3/033

(52) U.S. Cl. 345/166

(57) ABSTRACT

Various embodiments of optical mice are disclosed. One embodiment comprises a light source configured to emit light having a wavelength in or near a blue region of a visible light spectrum toward a tracking surface at an oblique angle to the tracking surface, an image sensor positioned to detect non-specular reflection of the light from the tracking surface, and one or more lenses configured to form a focused image of the tracking surface on the image sensor at the wavelength in or near the blue region of the visible light spectrum emitted by the light source. Further, the optical mouse comprises a controller configured to receive image data from the image sensor and to identify a tracking feature in the image data.

### BACKGROUND

An optical computer mouse uses a light source and image sensor to detect mouse movement relative to an underlying tracking surface to allow a user to manipulate a location of a virtual pointer on a computing device display. Two general types of optical mouse architectures are in use today: oblique architectures and specular architectures. Each of these architectures utilizes a light source to direct light onto an underlying tracking surface and an image sensor to acquire an image of the tracking surface. Movement is tracked by acquiring a series of images of the surface and tracking changes in the location(s) of one or more surface features identified in the images via a controller.

An oblique optical mouse directs light toward the tracking surface at an oblique angle to the tracking surface, and light scattered off the tracking surface is detected by an image detector positioned approximately normal to the tracking surface. Contrast of the surface images is enhanced by shadows created by surface height variations, allowing tracking features on the surface to be distinguished. Oblique optical mice tend to work well on rough surfaces, such as paper and manila envelopes, as there is sufficient non-specular scattering of light from these surfaces for suitable image sensor performance. However, an oblique optical mouse may not work as well on shiny surfaces, such as whiteboard, glazed ceramic tile, marble, polished/painted metal, etc., as most of the incident light is reflected off at a specular angle, and little light reaches the detector.

### SUMMARY

Accordingly, embodiments of optical mice configured to track well on a broad suite of surfaces are described herein. In one disclosed embodiment, an optical mouse comprises a light source configured to emit light having a wavelength in or near a blue region of a visible light spectrum toward a tracking surface at an oblique angle to the tracking surface, an image sensor positioned to detect non-specular reflection of the light from the tracking surface, and one or more lenses configured to form a focused image of the tracking surface on the image sensor at the wavelength in or near the blue region of the visible light spectrum emitted by the light source. Further, the optical mouse comprises a controller configured to receive image data from the image sensor and to identify a tracking feature in the image data.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an embodiment of an optical mouse.

FIG. 2 shows an embodiment of an optical architecture for the mouse of FIG. 1.

FIG. 3 shows a schematic diagram illustrating the reflection and transmission of light incident on a transparent dielectric slab.

FIG. 4 shows a schematic model of a tracking surface as a collection of dielectric slabs.

FIG. 5 illustrates a penetration depth of beam of light incident on a metal surface.

FIG. 6 shows a graph of a comparison of a reflectivity of white paper with and without optical brightener.

FIG. 7 shows a graphical representation of a variation of an index of refraction of polycarbonate as a function of wavelength.

FIG. 8 shows a comparison of modulation transfer functions for a red light mouse and for various scenarios of retrofitting a red light mouse with a blue light source.

FIG. 9 shows a schematic representation of an optical system optimized for red light.

FIG. 10 shows a schematic representation of an optical system optimized for red light used with a blue light source.

FIG. 11 shows a schematic representation of a red light optical system modified to focus a blue light image on an image sensor.

FIG. 12 shows a schematic representation of an optical system optimized for blue light.

FIG. 13 shows a process flow depicting a method of tracking motion of an optical mouse across a tracking surface.

### DETAILED DESCRIPTION

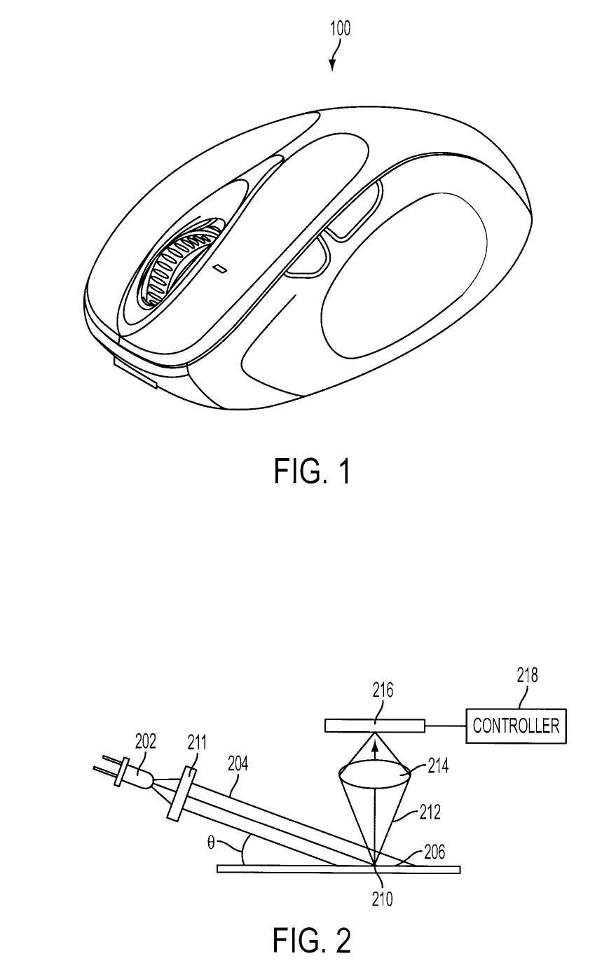

FIG. 1 shows an embodiment of an optical mouse 100, and FIG. 2 illustrates an embodiment of an optical architecture 200 for the optical mouse 100. The optical architecture 200 comprises a light source 202 configured to emit a beam of light 204 toward a tracking surface 206 such that the beam of light 204 is incident upon the tracking surface at a location 210. The beam of light 204 has an incident angle θ with respect to a plane of the tracking surface 206. The optical architecture 200 may further comprise a collimating lens 211 disposed between the light source 202 and the tracking surface 206 for collimating the beam of light 204. While FIG. 1 depicts a portable mouse, it will be understood that the architecture depicted may be used in any other suitable mouse.

The light source 202 is configured to emit light in or near a blue region of the visible spectrum. The terms “in or near a blue region of the visible spectrum”, as well as “blue”, “blue light”, “blue light source”, and the like as used herein describe light comprising one or more emission lines or bands in or near a blue region of a visible light spectrum, for example, in a range of 400-490 nm. These terms may also describe light within the near-UV to near-green range that is able to activate or otherwise enjoy the advantage of optical brighteners sensitive to blue light, as described in more detail below.

In various embodiments, the light source 202 may be configured to output incoherent light or coherent light, and may utilize one or more lasers, LEDs, OLEDs (organic light emitting devices), narrow bandwidth LEDs, or any other suitable light emitting device. Further, the light source 202 may be configured to emit light that is blue in appearance, or may be configured to emit light that has an appearance other than blue to an observer. For example, white LED light sources may utilize a blue LED die (comprising InGaN, for example) either in combination with LEDs of other colors, in combination with a scintillator or phosphor such as cerium-doped yttrium aluminum garnet, or in combination with other structures that emit other wavelengths of light, to produce light that appears white to a user. In yet another embodiment, the light source 202 comprises a generic broadband source in combination with a band pass filter that passes blue light. Such light sources fall within the meaning of “blue light” and “blue light source” as used herein due to the presence of blue wavelengths in the light emitted from these structures.

Continuing with FIG. 2, some portion of the incident beam of light 204 reflects from the tracking surface 206, as indicated at 212, and is imaged by a lens 214 onto an image sensor 216. As shown in FIG. 2, the light source 202 is positioned such that the incident beam of light has an oblique angle relative to the tracking surface, and the image sensor 216 is positioned to detect non-specular reflection 206 of the incident beam of light 204. The use of an incident beam of light 204 with an oblique angle relative to the tracking surface allows shadows formed by the interaction of the incident beam of light 204 with tracking surface features to be detected as tracking features. As described below, the use of a blue light source with an oblique optical architecture may offer advantages over the use of other colors of light in an oblique optical mouse that help to improve performance on a variety of tracking surfaces.

Continuing with FIG. 2, the image sensor 216 is configured to provide image data to a controller 218. The controller 218 is configured to acquire a plurality of time-sequenced frames of image data from the image sensor 216, to process the image data to locate one or more tracking features in the plurality of time-sequenced images of the tracking surface 206, and to track changes in the location(s) of the plurality of time-sequenced images of the tracking surfaces to track motion of the optical mouse 100. The locating and tracking of surface features may be performed in any suitable manner, and is not described in further detail herein.

The incident beam of light 204 may be configured to have any suitable angle with the tracking surface 206. Generally, in an oblique optical architecture, the incident beam of light 204 is configured to have a relatively shallow angle with respect to the tracking surface normal. Examples of suitable angles include, but are not limited to, angles in a range of 0 to 45 degrees relative to a plane of the tracking surface. It will be appreciated that this range of angles is set forth for the purpose of example, and that other suitable angles outside of this range may be used.

The image sensor 216 may be configured to detect light at any suitable angle relative to the tracking surface normal. Generally, the intensity of reflected light may increase as the image sensor 216 is positioned closer to the specular angle of reflection. For a light source that emits a beam at an angle within the above-identified range relative to the tracking surface plane, suitable detector angles include, but are not limited to, angles of 0 to ±10 degrees from the tracking surface normal.

As mentioned above, the use of a light source that emits light in or near a blue region of the visible spectrum may offer unexpected advantages over red and infrared light sources that are commonly used in LED and laser mice. These advantages may not have been appreciated due to other factors that may have led to the selection of red and infrared light sources over blue light sources. For example, currently available blue light sources may have higher rates of power consumption and higher costs than currently available red and infrared light sources, thereby leading away from the choice of blue light sources as a light source in an optical mouse. However, as described below, blue light offers various advantages, such as better contrast, higher reflective intensity, lower penetration depth, etc., compared to light of longer wavelengths.

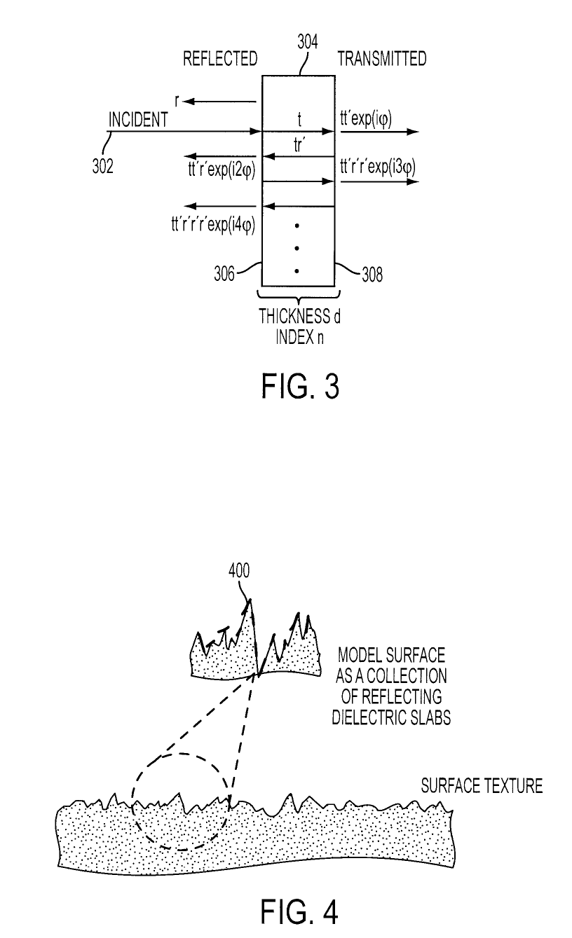

The advantages offered by blue light as defined herein arise at least partly from the nature of the physical interaction of blue light with reflective surfaces compared with red or infrared light. For example, blue light has a higher intensity of reflection from dielectric surfaces than red and infrared light. FIG. 3 illustrates the reflection of an incident beam of light 302 from a dielectric slab 304 made of a material transparent to visible light, having a thickness d, and having a refractive index n. As illustrated, a portion of the incident beam of light 302 is reflected off a front face 306 of the slab, and a portion of the light is transmitted through the interior of the slab 304. The transmitted light encounters the back face 308 of the slab, where a portion of the light is transmitted through the back face 308 and a portion is reflected back toward the front face 306. Light incident on the front face is again partially reflected and partially transmitted, and so on.

The light in the beam of incident light 302 has a vacuum wavelength λ. The reflection coefficient or amplitude, as indicated by r, and the transmission coefficient or amplitude, as indicated by t, at the front face 306 of the slab 304 are as follows:

$$r = \frac{( 1 - n )}{( 1 + n )}$$

$$t = \frac{2}{( 1 + n )}$$

At the back face 308 of the slab, the corresponding reflection coefficient, as indicated by r′, and the transmission coefficient, as indicated by t′, are as follows:

$${r}^{′} = \frac{( 1 - n )}{( 1 + n )}$$

$${t}^{′} = \frac{2 n}{( 1 + n )}$$

Note that the reflection and transmission coefficients or amplitudes depend only upon the index of refraction of the slab 304. When the incident beam of light strikes the surface at an angle with respect to the surface normal, the amplitude equations are also functions of angle, according to the Fresnel Equations.

A phase shift φ induced by the index of refraction of the slab 304 being different from the air surrounding the slab 304 is provided as follows:

$$ϕ = \frac{2 π nd}{λ}$$

Taking into account the transmission phase shift and summing the amplitudes of all the partial reflections and transmissions yields the following expressions for the total reflection and transmission coefficients or amplitudes of the slab:

$$\begin{matrix}R = r + {tt}^{†} {r}^{†} exp ( i2ϕ ) {\sum }_{m = 0}^{∞} {[ {r}^{†} exp ( iϕ ) ]}^{2 m} \\ = r + \frac{{r}^{†} {tt}^{†} exp ( i2ϕ )}{1 - {r}^{†2} exp ( i2ϕ )}\end{matrix}$$

$$\begin{matrix}T = {tt}^{†} exp ( iϕ ) {\sum }_{m = 0}^{∞} {[ {r}^{†} exp ( iϕ ) ]}^{2 m} \\ = \frac{{tt}^{†} exp ( i2ϕ )}{1 - {r}^{†2} exp ( i2ϕ )}\end{matrix}$$

At the limit of a small slab thickness d, the reflected amplitude equation reduces to a simpler form:

$$R \approx iπ d \frac{{n}^{2} - 1}{λ} exp [ \frac{iπ ( {n}^{2} + 1 ) d}{λ} ]$$

At this limit, the reflected light field leads the incident light field by 90 degrees in phase and its amplitude is proportional to both 1/λ and the dielectric's polarizability coefficient (n²−1). The 1/λ dependence of the scattering amplitude represents that the intensity of the reflected light from a thin dielectric slab is proportional to 1/λ², as the intensity of reflected light is proportional to the square of the amplitude. Thus, the intensity of reflected light is higher for shorter wavelengths than for longer wavelengths of light.

From the standpoint of an optical mouse, referring to FIG. 4, and as described above with reference to FIG. 3, the tracking surface may be modeled as comprising a large number of reflective elements in the form of dielectric slabs 500, each oriented according to the local height and slope of the surface. Each of these dielectric slabs reflect incident light; sometimes the reflected light is within the numerical aperture of the imaging lens and is therefore captured by the lens, and other times the light is not captured by the lens, leading to a dark tracking feature at the detector. Operation in the blue at 470 nm leads to an enhancement of the intensity of reflected light in the bright features by an amount of 850²/470²≃3.3 over infrared light having a wavelength of 850 nm, and a factor of 630²/470²≃1.8 over red light having a wavelength of 630 nm. This leads to a contrast improvement in the blue light images at the detector, because bright features on the detector are brighter than they appear in corresponding red or infrared images. These higher contrast images enable the acceptable identification and more robust tracking of tracking features with lower light source intensities, and therefore may improve the tracking performance relative to infrared or red light mice on a variety of surfaces, while also reducing the power consumption and increasing battery life.

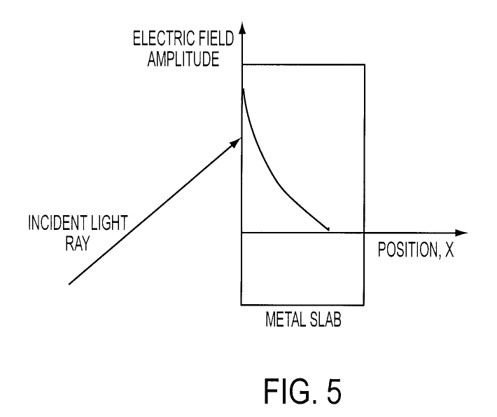

FIG. 5 illustrates another advantage of the use of blue light over red or infrared light in an optical mouse, in that the penetration depth of blue light is less than that of red or infrared light. Generally, the electric field of radiation incident on a surface penetrates the surface to an extent. FIG. 5 shows a simple illustration of the amplitude of an electric field within a metal slab as a function of depth. As illustrated, the electric field of the incident beam of light decays exponentially into the metal with a characteristic e-fold distance that is proportional to the wavelength. Given this wavelength dependency, infrared light may extend a factor of 1.8 times farther than blue light into a metal material. Short penetration depths also occur when blue light is incident upon non-metal, dielectric surfaces, as well; the exact penetration depth depends upon the material properties.

The lesser penetration depth of blue light compared to red and infrared light may be advantageous from the standpoint of optical navigation applications for several reasons. First, the image correlation methods used by the controller to follow tracking features may require images that are in one-to-one correspondence with the underlying navigation surface. Reflected light from different depths inside the surface can confuse the correlation calculation. Further, light that leaks into the material results in less reflected light reaching the image detector.

Additionally, the lesser penetration depth of blue light is desirable as it may lead to less crosstalk between adjacent and near-neighbor pixels and higher modulation transfer function (MTF) at the image sensor. To understand these effects, consider the difference between a long wavelength infrared photon and a short wavelength blue photon incident upon a silicon CMOS detector. The absorption of a photon in a semiconductor is wavelength dependent. The absorption is high for short wavelength light, but decreases for long wavelengths as the band-gap energy is approached. With less absorption, long wavelength photons travel farther within the semiconductor, and the corresponding electric charge generated inside the material must travel farther to be collected than the corresponding charge produced by the short wavelength blue photon. With the larger travel distance, charge carriers from the long wavelength light are able to diffuse and spread-out within the material more than the blue photons. Thus, charge generated within one pixel may induce a spurious signal in a neighboring pixel, resulting in crosstalk and an MTF reduction in the electro-optical system.

As yet another advantage to the use of blue light over other light sources, blue light is able to resolve smaller tracking features than infrared or red light. Generally, the smallest feature an optical imaging system is capable of resolving is limited by diffraction. Rayleigh's criteria states that the size d of a surface feature that can be distinguished from an adjacent object of the same size is given by the relationship

$$d \geq \frac{λ}{NA} ,$$

where λ is the wavelength of the incident light and NA is the numerical aperture of the imaging system. The proportionality between d and λ indicates that smaller surface features are resolvable with blue light than with light of longer wavelengths. For example, a blue mouse operating at λ=470 nm with f/l optics can image features down to a size of approximately 2λ≠940 nm . For an infrared VCSEL (vertical-cavity surface-emitting laser) operating at 850 nm, the minimum feature size that may be imaged increases to 1.7 μm. Therefore, the use of blue light may permit smaller tracking features to be imaged with appropriate image sensors and optical components.

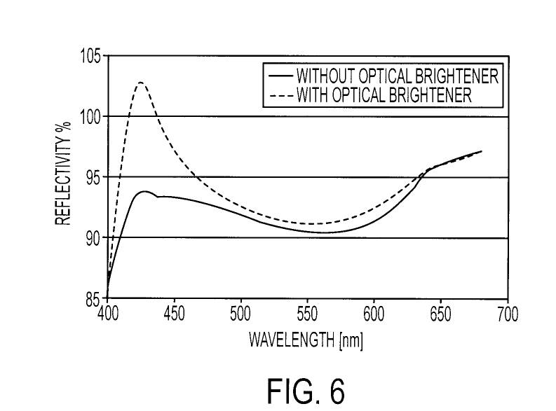

Blue light may also have a higher reflectivity than other wavelengths of light on various specific surfaces. For example, FIG. 6 shows a graph of the reflectivity of white paper with and without optical brightener across the visible spectrum. An “optical brightener” is a fluorescent dye that is added to many types of paper to make the paper appear white and “clean”. FIG. 6 shows that white paper with an optical brightener reflects relatively more in and near a blue region of a visible light spectrum than in other some other regions of the spectrum. Therefore, using light in or near a blue region of a visible light spectrum as a mouse light source may lead to synergistic effects when used on surfaces that include optical brighteners, as well as other such fluorescent or reflectively-enhanced tracking surfaces, thereby improving mouse performance on such surfaces to an even greater degree than on other surfaces.

Such effects may offer advantages in various use scenarios. For example, a common use environment for a portable mouse is a conference room. Many conference room tables are made of glass, which is generally a poor surface for optical mouse performance. To improve mouse performance on transparent surfaces such as glass, users may place a sheet of paper over the transparent surface for use as a makeshift mouse pad. Therefore, where the paper comprises an optical brightener, synergistic effects in mouse performance may be realized compared to the use of other surfaces, allowing for reduced power consumption and therefore better battery life for a battery operated mouse.

Similar synergistic effects in performance may be achieved by treating or preparing other surfaces to have brightness-enhancing properties, such as greater reflectivity, fluorescent or phosphorescent emission, etc., when exposed to light in or near a blue portion of the visible spectrum. For example, a mouse pad or other dedicated surface for mouse tracking use may comprise a brightness enhancer such as a material with high reflectivity in the blue range, and/or a material that absorbs incident light and fluoresces or phosphoresces in the blue range. When used with a blue light mouse, such a material may provide greater contrast than surfaces without such a reflective or fluorescent surface, and thereby may lead to good tracking performance, low power consumption, etc.

In the case of an oblique laser mouse, the use of blue coherent light may offer advantages over the use of red or infrared coherent light regarding speckle size. Because the speckle size is proportional to the wavelength, blue coherent light generates smaller speckles than either a red or infrared laser light source. In some laser mice embodiments it is desirable to have the smallest possible speckle, as speckle may be a deleterious noise source and may degrade tracking performance. A blue laser has relatively small speckle size, and hence more blue speckles will occupy the area of a given pixel than with a red or infrared laser. This may facilitate averaging away the speckle noise in the images, resulting in better tracking.

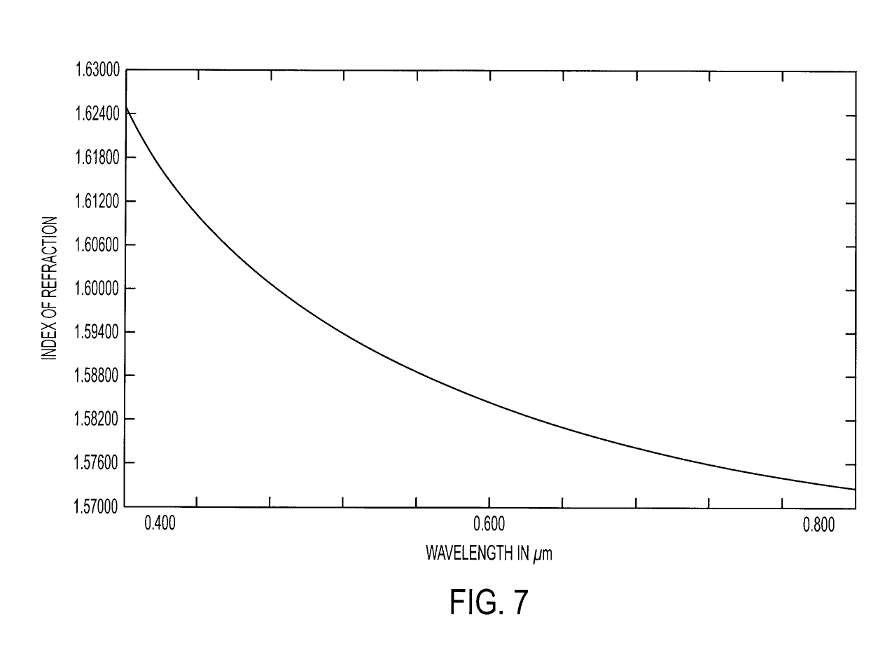

The advantages of using a blue light source may not be fully realized by the simple conversion or retrofitting of a red light mouse with a blue light source. For example, FIG. 7 shows a plot of the refractive index of an example lens material (polycarbonate) as a function of wavelength. From this figure, it can be seen that the refractive index is inversely proportional to the wavelength of light. Therefore, the index of refraction is higher for blue light than for red light. The refractive indices of other materials than polycarbonate may vary with wavelength to a different degree than polycarbonate, but have a similar inverse proportionality. As a result of this property, a blue-light image is focused by a lens at a different point than a red light image. Therefore, depending upon optical system parameters such as depth of focus, such a difference may cause substantial image blurring, and therefore lead to poor motion tracking.

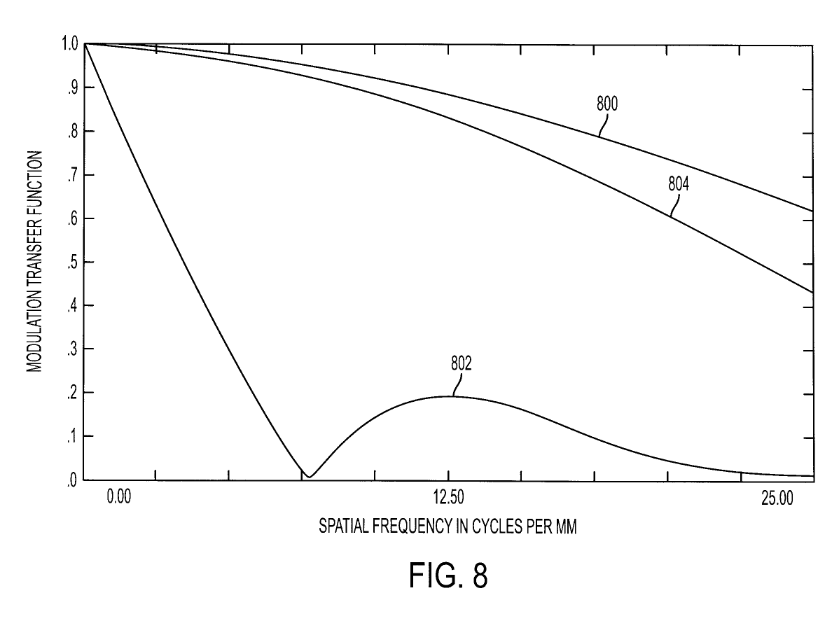

Other detrimental effects may likewise arise from this property of light. For example, image contrast may be decreased by using a blue light source in a mouse configured for red light. FIG. 8 shows a comparison of the modulation transfer function for an optical system optimized for use with red light a wavelength of 630 nm at the optimal light source wavelength 800, and also under two different blue light source retrofit scenarios. First, at 802, FIG. 8 shows the modulation transfer function for the red light optical system used with blue light having a wavelength of 470 nm, and with no further adjustments. Next, at 804, FIG. 8 shows the modulation transfer function for the red light optical system used with 470 nm blue light, and having the system adjusted such that a blue-light image is focused on the image sensor, rather than a red light image. As shown, the modulation transfer function is substantially lower for the simple substitution of a blue light source into a red light optical system compared to the use of red light, and approaches zero at various spatial frequencies. As a result, much contrast is lost when a blue light is substituted into a red light mouse. This may result in unacceptable performance degradation. Likewise, even the adjustment of the optical system to focus the blue-light image on the image sensor of a red light optical mouse may still lead to reduced contrast, as shown at 804.

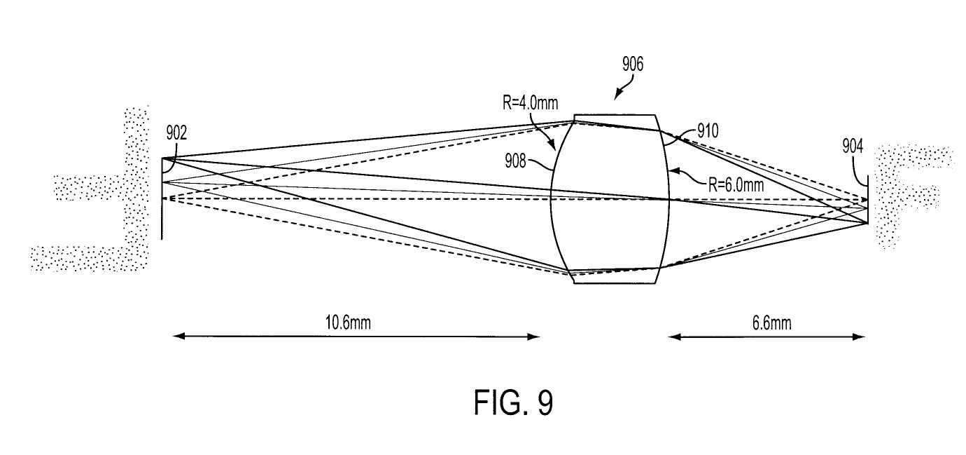

Other properties besides contrast may be affected by the retrofitting of a red light optical system with a blue light source. For example, such a retrofitting may change a magnification of an image focused on the image sensor, and also may introduce optical aberrations. Magnification affects performance in an optical mouse, as it determines a resolution (dots-per-inch) and the maximum velocity and acceleration trackable by the mouse. These concepts are illustrated qualitatively in FIGS. 9-11. First, FIG. 9 shows the focusing of an image from a tracking surface 902 (located at the object plane) on an image sensor 904 (located at the image plane) in a red light optical system using red light having a wavelength of 630 nm and a bi-convex lens 906 configured to demagnify and focus an image on the image sensor. The distance from the tracking surface to a first surface 908 of the lens is 10.6 mm, and the distance from a second lens surface 910 to the image sensor is 6.6 mm. Further, the radius of curvature of the first lens surface is 4.0 mm, and the radius of curvature of the second lens surface is −6.0 mm. The image magnification is −0.6 (−6.6 mm/10.6 mm). As illustrated, the use of red light with the red-light optimized optical system faithfully reproduces the “F” image on the image plane at a desired magnification. It will be appreciated that bi-convex lens 906 may represent one or more actual lenses, as well as other optical elements contained within a lens system.

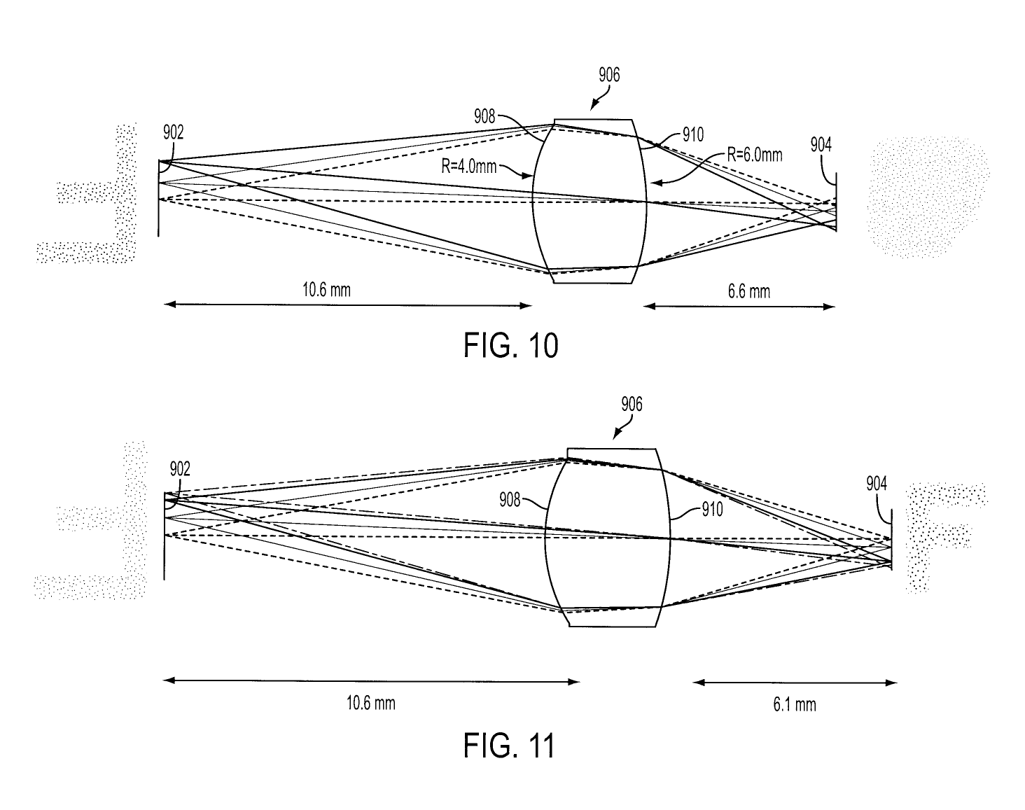

Next, FIG. 10 shows the same optical system illuminated with blue light having a wavelength of 470 nm. As can be seen, due to the higher index of refraction at this wavelength, the image is not focused on the image sensor 904. This causes the “F” to appear as a blurry spot on the image sensor 904, which may lead to poor motion tracking by the mouse.

FIG. 11 shows the same optical system illuminated with 470 nm blue light, but with the image sensor 906 moved to a distance of 6.1 mm from the second lens surface 910 to focus the blue light image on the image sensor. While this leads to a focused image, the magnification of the mouse has decreased by approximately 8% to 0.58 (−6.1 mm/10.6 mm). This leads to a reduction in the resolution (dpi, or “dots per inch”) of the mouse, and potentially worse tracking performance.

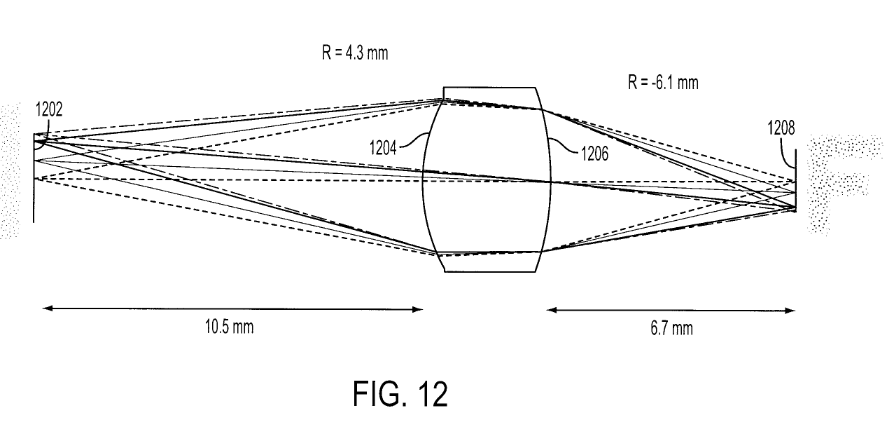

Next, FIG. 12 shows an optical system configured to focus a blue-light image on an image sensor. Compared to the red light optical system shown in FIGS. 9-10, the radii of curvature of the bi-convex lens, as well as the distance from the image sensor to the second lens surface, are optimized for 470 nm light to preserve the same magnification and total length as the red light optical system. As shown, the distance from the tracking surface 1202 (object plane) to the first lens 1204 surface is 10.5 mm, and the distance from the second lens surface 1206 to the image plane 1208 is 6.7 mm. Further, the radii of curvature of the first and second lens surfaces are 4.3 mm and −6.1 mm, respectively. With these measurements, the same magnification and total length are maintained compared to the red light optical system shown above in FIG. 9 while focusing a sharp blue-light image on the image detector 1208.

As illustrated in these figures, merely changing the location of the image sensor to the blue light image plane does not preserve the magnification, contrast and other image properties of a red light optical system when used with a blue light. Instead, the lens shapes and the distances between the various optical elements also affect desired performance characteristics. It will be appreciated that the specific dimensions and distances shown in FIGS. 9-12 are shown for the purpose of example, and that a blue light optical system may have any suitable configuration other than that shown.

In light of the physical properties described above, the use of blue light may offer various advantages over the use of red light or infrared light in an optical mouse. For example, the higher reflectivity and lower penetration depth of blue light compared to red or infrared light may allow for the use of a lower intensity light source, thereby potentially increasing battery life. This may be particularly advantageous when operating a mouse on white paper with an added brightness enhancer, as the intensity of fluorescence of the brightness enhancer may be strong in the blue region of the visible spectrum. Furthermore, the shorter coherence length and smaller diffraction limit of blue light compared to red light from an optically equivalent (i.e. lenses, f-number, image sensor, etc.) light source may allow both longer image feature correlation lengths and finer surface features to be resolved, and therefore may allow a blue light mouse to be used on a wider variety of surfaces. Examples of surfaces that may be used as tracking surfaces for a blue optical mouse include, but are not limited to, paper surfaces, fabric surfaces, ceramic, marble, wood, metal, granite, tile, stainless steel, and carpets including Berber and deep shag.

Further, in some embodiments, an image sensor, such as a CMOS sensor, specifically configured to have a high sensitivity (i.e. quantum yield) in the blue region of the visible spectrum may be used in combination with a blue light source. This may allow for the use of even lower-power light sources, and therefore may help to further increase battery life.

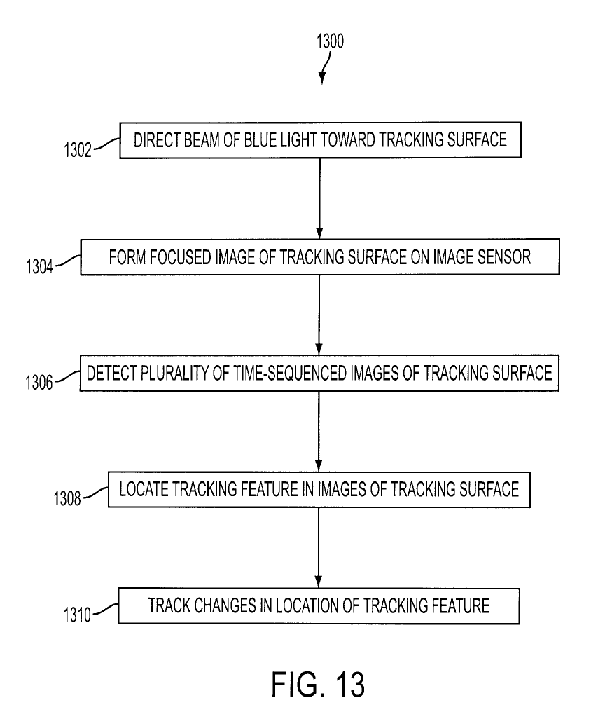

Continuing with the Figures, FIG. 13 shows a process flow depicting an embodiment of a method 1300 of tracking a motion of an optical mouse across a surface. Method 1300 comprises, at 1302, directing an incident beam of light emitted from a blue light source as defined herein toward a tracking surface at an oblique angle to the tracking surface, forming, at 1303, a focused image of the tracking surface on an image sensor at the blue wavelength emitted by the light source, and then detecting, at 1304, a plurality of time-sequenced images of the tracking surface via an image sensor configured to detect an image of the surface. Next, method 1300 comprises, at 1306, locating a tracking feature in the plurality of time-sequenced images of the tracking surface, and then, at 1308, tracking changes in the location of the tracking feature in the plurality of images. An (x,y) signal may then be provided by the optical mouse to a computing device for use by the computing device in locating a cursor or other indicator on a display screen.

It will be understood that the configurations and/or approaches described herein are exemplary in nature, and that these specific embodiments or examples are not to be considered in a limiting sense, because numerous variations are possible. The subject matter of the present disclosure includes all novel and nonobvious combinations and subcombinations of the various processes, systems and configurations, and other features, functions, acts, and/or properties disclosed herein, as well as any and all equivalents thereof.

1. An optical mouse, comprising:
a light source configured to emit light having a wavelength in or near a blue region of a visible light spectrum toward a tracking surface at an oblique angle to the tracking surface;
an image sensor positioned to detect non-specular reflection of the light from the tracking surface;
one or more lenses configured to form a focused image of the tracking surface on the image sensor at the wavelength in or near the blue region of the visible light spectrum emitted by the light source; and
a controller configured to receive image data from the image sensor and to identify a tracking feature in the image data.

2. The optical mouse of claim 1, wherein the light source is configured to emit light comprising a wavelength within a range of 400 nm to 490 nm.

3. The optical mouse of claim 1, wherein the light source is configured to emit light of a wavelength that causes fluorescence or phosphorescence to be emitted by a brightness enhancer in the tracking surface.

4. The optical mouse of claim 3, wherein the light source is configured to form a beam of light having an angle of between 0 and 45 degrees with respect to the tracking surface normal.

5. The optical mouse of claim 1, wherein the image sensor is positioned to detect light in a range of ±10 degrees with respect to a tracking surface normal.

6. The optical mouse of claim 1, wherein the optical mouse is a portable mouse.

7. The optical mouse of claim 1, wherein the light source comprises a light-emitting diode configured to emit blue light.

8. The optical mouse of claim 1 wherein the light source comprises a light-emitting diode configured to emit white light.

9. The optical mouse of claim 1, wherein the detector is a CMOS image sensor configured to have a high sensitivity to blue light.

10. An optical mouse, comprising:
a light source configured to emit light having a wavelength of between 400-490 nm toward a tracking surface at an angle of between 0 and 45 degrees relative to a plane of the tracking surface;
an image sensor positioned at an angle of between −10 and 10 degrees relative to a tracking surface normal;
one or more lenses configured to form a focused image of the tracking surface on the image sensor at the wavelength of the light emitted by the light source; and
a controller configured to receive image data from the image sensor and to identify a tracking feature in the image data.

11. The optical mouse of claim 10, wherein the image sensor is a CMOS image sensor configured to have a high sensitivity to light of the wavelength emitted by the light source.

12. The optical mouse of claim 10, wherein the optical mouse is a portable mouse.

13. The optical mouse of claim 10, wherein the light source comprises a light emitting diode configured to emit one of white light and blue light.

14. The optical mouse of claim 10, wherein the light source comprises a laser.

15. The optical mouse of claim 10, wherein the light source comprises a broadband source and a band pass filter.

16. A method of tracking motion of an optical mouse, comprising:
directing an incident beam of light having a wavelength in or near a blue region of a visible light spectrum toward a tracking surface at an oblique angle relative to the tracking surface;
forming a focused image of the tracking surface on an image sensor positioned to detect non-specular reflection of the light from the tracking surface;
capturing a plurality of time-sequenced images of the tracking surface;
locating a tracking feature in the plurality of time-sequenced images of the tracking surface; and
tracking changes in location of the tracking feature across the plurality of time-sequenced images of the tracking surface.

17. The method of claim 16, wherein directing an incident beam of light toward a tracking surface comprises directing the incident beam of light toward a tracking surface comprising a brightness enhancer.

18. The method of claim 16, wherein directing an incident beam of light toward the tracking surface comprises directing an incident beam of light with a wavelength in a range of 400 to 490 nm.

19. The method of claim 16, wherein detecting a plurality of time-sequenced images of the tracking surface comprises detecting light reflected from the surface at an angle in a range of between −10 and 10 degrees from a tracking surface normal.

20. The method of claim 16, wherein directing the incident beam of light toward the tracking surface comprises directing the incident beam of light toward the tracking surface at an angle in a range of 0 to 45 degrees relative to a plane of the tracking surface.
